(19) United States
(12) Patent Application Publication
(10) Pub. No.: US 2012/0164366 A1
(43) Pub. Date: Jun. 28, 2012

(54) DECORATIVE ACCESSORY

(76) Inventor: Aubren M. Johnson, Draper, UT (US)

(21) Appl. No.: 13/172,409

(22) Filed: Jun. 29, 2011

Related U.S. Application Data
(63) Continuation-in-part of application No. 12/146,091, filed on Jun. 25, 2008, now Pat. No. 8,112,963.

(51) Int. Cl. B44F 3/00; A63H 3/00; B32B 3/06; B32B 3/02; B44F 7/00; B32B 3/24

(52) U.S. Cl. 428/80; 428/131; 428/99; 446/268

(57) ABSTRACT

A decorative accessory unit, a decorative accessory assemblage, a kit for a personal accessory craft project and a method for creating a personal accessory are described. A plurality of decorative units having at least two linking ends protruding there from are provided along with a plurality of connector elements for coupling the linking ends of two decorative units together.

### PRIORITY CLAIM

This application is a continuation-in-part of U.S. Ser. No. 12/146,091 entitled “Decorative Accessory” field Jun. 25, 2008 which is hereby incorporated in its entity by reference thereto.

### SUMMARY

According to a first aspect of the invention, there is provided a decorative accessory unit including a body and at least two linking ends. The body includes a generally planar material having edges defining a shape and the body having front and rear surfaces. The at least two linking ends protrude from the edges of the body and each linking end includes a stretchable material having at least one connection aperture passing therethrough, each connection aperture configured to receive a connector.

According to a second aspect of the invention, there is provided a decorative item including a body, a plurality of apertures located in the body and a plurality of connectors. The body is of a generally planar material having a thickness and having edges defining a shape, the body having a front surface and a rear surface. The plurality of apertures are located in the body and pass through the thickness of the body. The plurality of connectors each connector having a front, a back and a shank coupling the front to the back of the connector. The back of the connector is larger than the aperture and fits through the aperture to accommodate the back of the connector so that the back of the connector passes through the aperture and the shank resides substantially in the aperture so that the front of the connector is located on the front surface of the body and the back of the connector is located on the rear surface of the body and wherein the front of the connector has a decorative appearance.

According to a third aspect of the invention, there is provided a kit for decorative items including a plurality of bodies and a plurality of connectors. each body of the plurality of bodies includes a generally planar material having a thickness and having edges defining a shape, each body having a front surface and a rear surface. a plurality of apertures are located in each of the plurality of bodies and pass through the thickness of each body.

The plurality of connectors, each have a front, a back and a shank coupling the front to the back of the connector, wherein the back of the connector is larger than the aperture and fits through the aperture to accommodate the back of the connector so that the back of the connector passes through the aperture and the shank resides substantially in the aperture so that the front of the connector is located on the front surface of the body and the back of the connector is located on the rear surface of the body and wherein the front of the connector has a decorative appearance.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1 is a perspective view of a decorative accessory according to one embodiment of the invention.

FIG. 2 is a perspective view of a decorative accessory according to one embodiment of the invention.

FIG. 3 is a perspective view of a decorative accessory according to one embodiment of the invention.

FIG. 4 is a perspective view of a connector according to one embodiment of the invention.

FIG. 5 is a perspective view of a connector according to one embodiment of the invention.

FIG. 6 is a perspective view of a connector according to one embodiment of the invention.

FIG. 7 is a perspective view of a connector according to one embodiment of the invention.

FIG. 8A is perspective view of a decorative accessory unit including a strap according to some embodiments of the invention.

FIG. 8B is a side plan view of a decorative accessory unit including a strap according to some embodiments of the invention.

FIG. 8C is a side plan view of a decorative accessory unit including a strap according to some embodiments of the invention.

FIG. 9A is a perspective view of a decorative accessory unit including a loopable end, according to some embodiments of the invention.

FIG. 9B is a perspective view of a decorative accessory unit including a loopable end formed into a loop, according to some embodiments of the invention.

FIG. 10A is a perspective view of a decorative accessory assemblage according to some embodiments of the invention.

FIG. 10B is a side plan view of a decorative accessory assemblage according to some embodiments of the invention.

FIG. 11A is a top plan view of a linking end according to some embodiments of the invention.

FIG. 11B is a side plan view of the linking end of FIG. 11A.

FIG. 11C is a perspective view of linking ends including recessed apertures according to some embodiments of the invention.

FIG. 12 illustrates front views of an assembled decorative item and an unadorned decoratable item including various decorative connectors according to an embodiment of the invention.

FIGS. 13a and b are perspective views of the front and rear respectively is a connector according to a preferred embodiment of the invention.

FIG. 14 is a perspective side view of the connector shown in FIGS. 13a and b.

FIGS. 15a and b are perspective views of the front and rear respectively is a connector according to a preferred embodiment of the invention.

FIG. 16 is a perspective side view of the connector shown in FIGS. 15a and b.

FIGS. 17-22 illustrate front views of assembled decorative items according to multiple embodiments of the invention.

FIG. 23 illustrates front views of assembled decorative items as well as its unassembled parts according to another embodiment of the invention.

FIG. 24 illustrates front views of assembled decorative items as well as unassembled parts according to another embodiment of the invention.

FIG. 25 illustrates front views of an assembled decorative item as well as unassembled parts according to another embodiment of the invention.

FIGS. 26a and b illustrate front views of two assembled decorative items according to another embodiment of the invention.

FIGS. 27a and b are shaped that can be used in conjunction with the connectors desired herein.

FIG. 28 is a front view of a building in its unconstructed state according to a preferred embodiment of the invention.

FIG. 29 is a rear view of the building shown in FIG. 28.

FIGS. 30a and b are front and rear perspective views of the building shown in FIGS. 28 and 29 in its constructed state.

FIGS. 31 and 32 illustrate villages that can be created with building using the principles of the invention.

FIGS. 33 and 34 also illustrate holiday-themed buildings.

FIG. 35 illustrate a park that can also be built using bodies according to the embodiments of the invention.

FIG. 36 is a perspective view of another embodiment of the invention.

FIG. 37 illustrates another embodiment of the invention.

FIG. 38 is similar but instead of the body being a clip, it is a headband 1060 having multiple apertures to which a decorative connector and/or overlays may be secured.

FIG. 39 illustrates a purse utilizing the same concept.

FIG. 40 shows and three-dimensional body that is hollow in the interior and has a plurality of apertures through which decorative connectors with or with out overlays may be attached.

### DETAILED DESCRIPTION OF THE DRAWINGS

For the purpose of promoting an understanding of the principles of the invention, reference will now be made to the embodiments illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

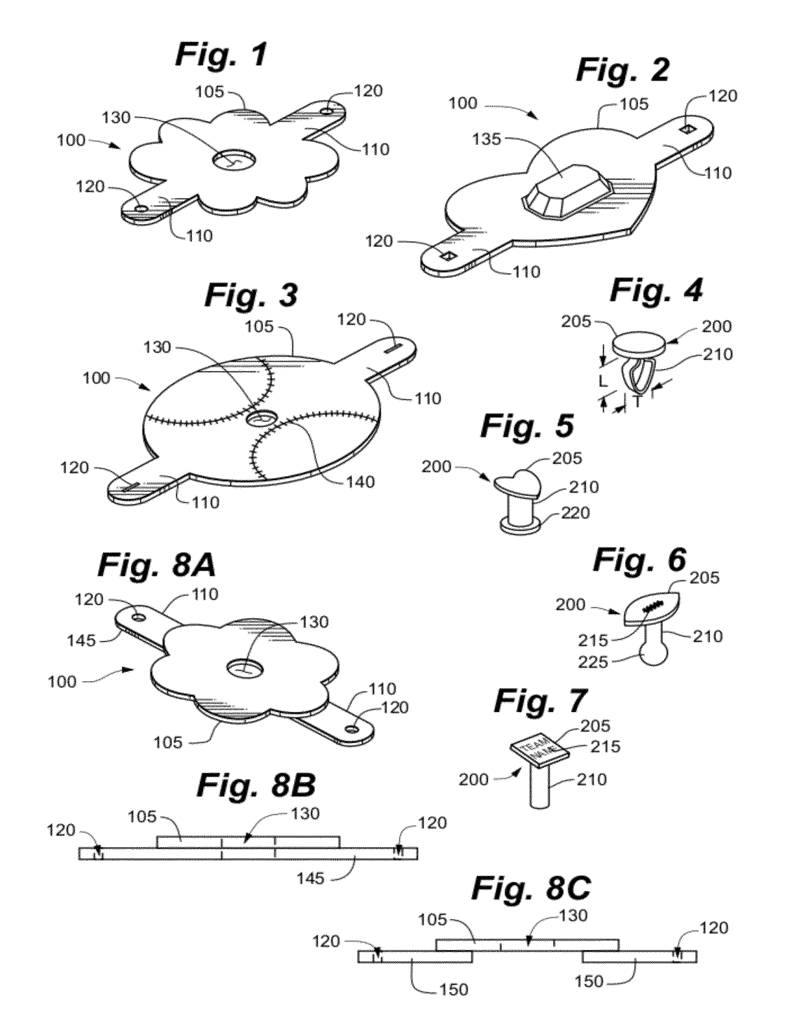

As is shown in FIG. 1, embodiments of the invention include a decorative accessory unit 100. The decorative accessory unit 100 includes a body 105 and at least two linking ends 110 protruding from the edges of the body 105. In some embodiments, connectors (such as those in FIGS. 4-7) can be installed through connection apertures 120 in the linking ends 110 to couple two or more decorative accessory units together to form a decorative accessory assemblage 300 (see e.g. FIG. 10A).

Referring again to FIG. 1, the body 105 of the decorative accessory unit 100 is generally planar with front and rear surfaces and can include a variety of features. Most notably, the body 105 can comprise a variety of shapes. The embodiment of FIG. 1 can be described as having a flower shape. Numerous other shapes can be appropriate for decorative accessory units according to the embodiments of the present invention. For example, the body 105 of FIG. 2 is heart-shaped and the unit 100 of FIG. 3 has a circular body 105. In some embodiments, the body includes an aperture 130 configured to receive an ornament. The aperture 130 can be centrally located relative to the edges of the body 105 or otherwise positioned. For example, the embodiment of FIG. 2, includes an ornament 135 installed through the aperture. The ornament 135 may have a flat surface or it may have a three-dimensional surface as shown in FIG. 2. In addition, some embodiments include a decorative design 140 of the body 105. The design can be printed, etched, painted, or otherwise displayed on one or more surfaces of the body 105. For example the decorative accessory unit 100 of FIG. 3 includes a baseball stitch design 140 printed on its front surface. Also, various visually enhancing elements such as glitter may be used for both the body 105 and the connectors 200 which will be described hereinafter.

At least two linking ends 110 protrude from the body 105 of decorative accessory units 100 according to the invention. In many embodiments, the unit includes two linking ends positioned diametrically opposite each other, however other arrangements and numbers of linking ends are contemplated by the invention, for example, there may be four linking ends, two from the sides, as shown, and one from the top and one from the bottom. Each linking end 110 is a generally planar extension formed of a stretchable material and including one or more connection apertures 120. Connection apertures 120 can be round (see e.g. FIG. 1), square (see e.g. FIG. 2), a slit (see e.g. FIG. 3), or otherwise shaped, so long as the connection aperture 120 is sized to appropriately interact with a connector installed within as discussed below with reference to FIGS. 10A and 10B.

In some embodiments, the body 105 and linking ends 110 comprise the same material. For example, the body 105 and linking ends 110 can both comprise ethylene vinyl acetate (EVA) foam. However, in certain embodiments the body 105 and linking ends 110 comprise different materials. In general, the body 105 comprises a decorative material, such as an injectable soft plastic such as LDPE or PVC. The linking ends 110 comprise a stretchable material such as EVA foam or rubber.

FIG. 8A shows a perspective view of a decorative accessory unit 100 according to embodiments of the invention including a strap 145. Here, rather than having linking ends integrally formed with or coupled to an edge or side of the body, the linking ends 110 comprise a strap 145 coupled to the rear of the body 105. Such an arrangement may be appropriate where the strap and body comprise different materials. FIGS. 8B and 8C show side plan views of embodiments wherein the linking ends comprise a strap such as that of FIG. 8A. In one (FIG. 8B) the strap 145 comprises a single length of stretchable material operatively coupled to the rear of the body 105. In such an arrangement, aperture 130 can extend through both the body 105 and the strap 145. In the other (FIG. 8C) the strap comprises at least two separate strap segments 150 separately coupled at different locations on the rear surface of the body 105. For example, the strap segments 150 can be coupled diametrically opposite one another relative to a centrally located aperture 130.

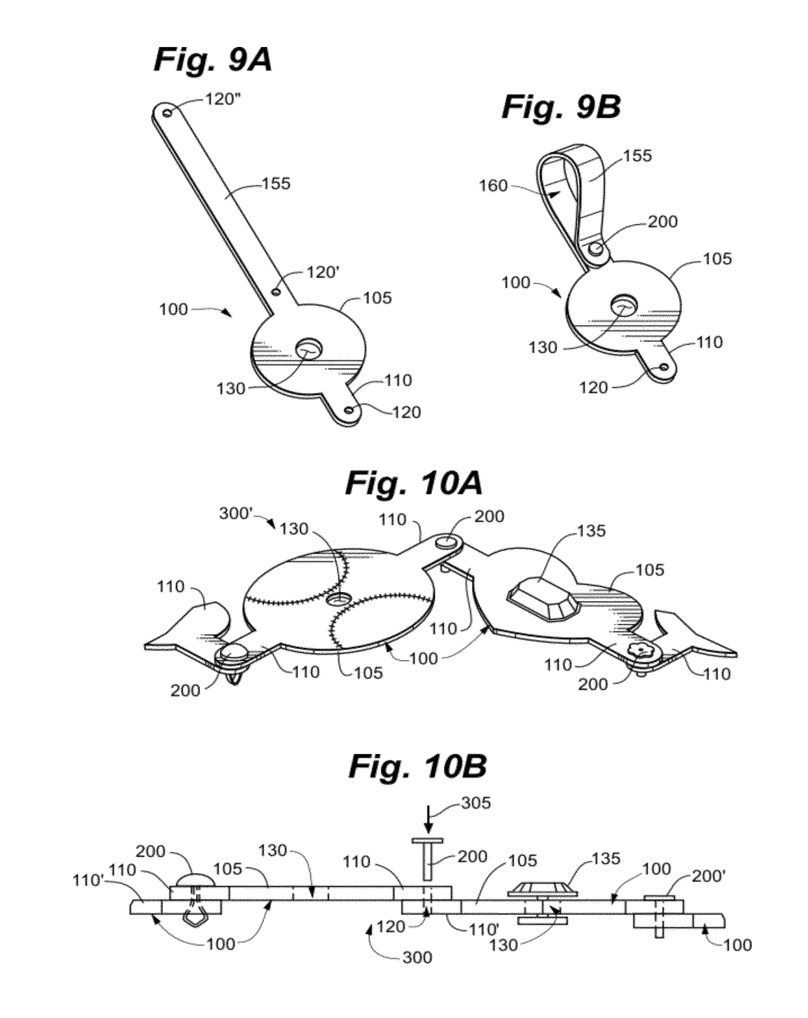

FIGS. 9A and 9B show embodiments of decorative accessory units 100 including a loopable end 155. In some embodiments, one or more of the linking ends 110 can be a loopable end 155. Loopable ends 155 are generally elongate linking ends having two or more connection apertures 120′, 120″. The first connection aperture 120′ can be located close to the body 105 with the second 120″ located at a tip of the loopable end 155. FIG. 9B illustrates how a loopable end can be used to create a loop 160 which can be used to attach the decorative accessory unit 100 or a decorative accessory assemblage including a unit having a loopable end to any number of objects such as a back pack or a belt loop, for example. To create the loop 160, the loopable end 155 has been folded so that the first and second connection apertures 120′, 120″ are aligned. A connector 200, such as one of the connectors described below, has been installed through the aligned connection apertures. A loopable end 155 can be coupled with the body 105 in the same manner as the linking ends discussed above. For example, a loopable end can be integrally formed with the body (such as e.g. the linking ends of FIG. 1), or can be coupled with a surface of the body (such as e.g. the strap of FIGS. 8A-9C).

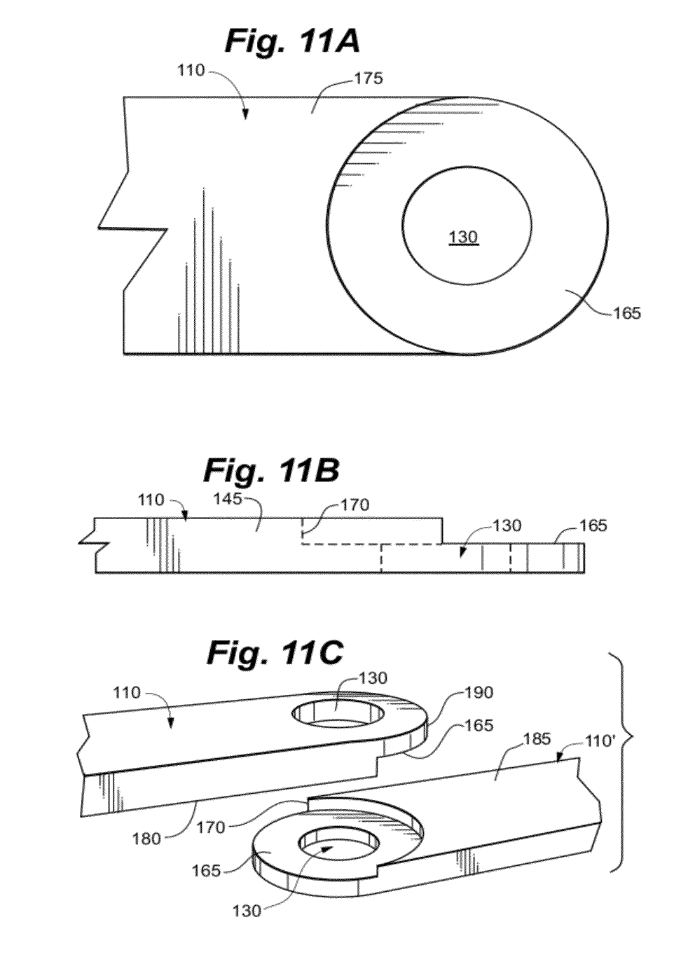

Some embodiments can include one or more linking ends having a recessed connection aperture, such as the linking ends 110 shown in FIGS. 11A-11C. In FIG. 11A, the operative end of a linking end 110 having a connection aperture 120 through a recessed surface 165 of the linking end 110. Here, the recessed surface 165 generally defines a circular shape having a diameter larger than that of the connection aperture 120, however other shapes are contemplated. The plan view of FIG. 11B shows a profile view of the linking end 110 of FIG. 11A. Here, the recessed surface 165 is noticeable and a ledge 170 defining the border between the recessed portion 165 and the unrecessed portion 175 can be seen. From this view, it can be seen that the recessed portion 165 retains a thickness of approximately one half that of the unrecessed portion 175. Thus, when embodiments including a recess 165 are aligned and engaged, the resulting connection is flush along the length of the linking element. FIG. 11C shows a perspective view of how linking ends 110, 110′ including recess 165 can be connected. Here, one linking end 110 is arranged such that the recessed surface 165 is on the rear surface 180 of the end, and the other 110′ is arranged such that the recessed surface 165 is on the front surface 185 of the end. When the linking ends 110, 110′ are placed immediately adjacent to one another, the connection apertures 120 can be aligned and the recesses receive each other. One can see that a flush connection can be established if the ledges 170 and operative ends 190 of the coupled linking ends 110, 110′ are generally the same thickness. Some decorative accessory units including such recess features can include at least one rearward oriented recess and at least one frontward oriented recess, so that consecutive elements need not be installed upside-down.

Exemplary connectors 200 according to embodiments of the invention are shown in FIGS. 4-7. Each connector generally includes a decorative portion 205 and an engaging portion 210. Connectors 200 should be generally rigid, and can comprise, for example, a plastic, hard rubber, or metal. The decorative portion 205 and engaging portion 210 need not comprise the same material. The connectors 200 can be used to connect successive selected decorative accessory units to form a decorative accessory assemblage. The connectors should provide for relatively simple connections to be formed so that embodiments of the invention are usable as craft projects or accessories for users of a wide range of ages, e.g. from young children to adults. According to some embodiments of the invention, the connectors are decorative and can provide an additional design element to a user creating a decorative assemblage. Thus, rather than using plain connector elements to couple successive accessory units, additional design elements can be injected by using a creative selection of connectors.

The decorative portion 205 of each connector can be a generally planar surface of a variety of standard or custom shapes. For example, decorative portions 205 can be circular (e.g. FIG. 4), heart-shaped (e.g. FIG. 5), football-shaped (e.g. FIG. 6), or rectangular (e.g. FIG. 7), for example. Appropriately sized decorative portions are broad enough so as not to slip through a connection aperture, yet small enough so as not to distract from design features of the decorative accessory unit. For example, a connector's decorative portion can be larger than 0.5 square cm and less than 4 square centimeters (e.g. 1 square cm). In various embodiments, the decorative portion 205 can include design features 215. For example, a relief design or drawing, for example, the stitches 215 on the football shaped connector 200 of FIG. 6. Moreover, a team logo, company name, image, or other design 205 may be printed, etched, engraved, molded, painted, or otherwise displayed on the decorative portion 205 (see e.g. FIG. 7). In addition, the decorative portion 205 can be flat or it may have a three-dimensional shape such as the surface of ornament 135 shown in FIG. 2. The connectors 200 may be provided with light emitting elements and/or sound emitting elements, for example, to further enhance the design and its versatility. Scratch and sniff elements may also be incorporated into the connectors and/or body 105.

The engaging portion 210 of the connectors 200 protrudes from a surface of the decorative portion 205. The engaging portion can be integrally formed of the decorative portion or may be a separate component coupled thereto. Thickness T and length L dimensions of the protrusion should be selected according to properties of the decorative assembly unit(s) in which the connector is to be installed. The thickness T should be slightly greater than the dimension of the connection apertures, and the length L should be slightly longer that the combined thickness of the linking ends to be connected. For example, a connector to be installed in two linking ends each having a thickness of 0.5 cm and connection apertures having a diameter of 0.5 cm should be greater than 1 cm in length (e.g. 1.2 cm) and greater than 0.5 cm thick (e.g. 0.6 cm). Engaging portion 210 can take numerous forms, such as a loop (see e.g. FIG. 4) or a post (see e.g. FIG. 7). In addition, some engaging portions include additional features to secure the connector once installed. These features can include, for example a collar or flange 220 (see e.g. FIG. 5), or a bulb 225 (see e.g. FIG. 6). The type of engaging portion used can depend upon the security/permanence of the connection desired, the connection aperture design and the material of the linking ends. For example, where the connection aperture engages the connector relatively loosely, for example with some circular apertures, it may be desirable to use a connector including an additional securing feature such as a flange.

It should be recognized that the embodiments of FIGS. 4-7 merely represent examples of connectors within the scope of the invention and these examples are by no means meant to be exhaustive. One of ordinary skill will recognize numerous other designs, configurations, and combinations, all of which should be considered within the scope of invention.

FIGS. 10A and 10B show perspective and side plan views, respectively, of a decorative accessory assemblage 300 according to some embodiments of the invention. The assemblage 300 includes a plurality of decorative accessory units 100 the linking ends 110 of which are connected by connectors 200. One or more bodies 105 of the decorative accessory units 100 can include an ornament 135 installed within an aperture 130.

A decorative assemblage 300 can be formed by coupling two or more decorative accessory units 100. To accomplish this, a user can align a connection aperture 120 of a first linking end 110 with a connection aperture of a second linking end 110′. Then, as shown in FIG. 10B, the engaging portion 210 of a connector 200 can be inserted (e.g. by pressing on the decorative portion 205, e.g. along arrow 305) through the aligned connection apertures, causing the stretchable material of the linking end to stretch slightly. When the connector 200 is installed, the apertures attempt to return to their initial state, thereby gripping the connector 200 in place.

Some assemblages can include one or more ornaments 135 installed through an aperture 130 of one or more bodies 105. Ornaments 135 can be installed prior to or after connecting one decorative accessory unit to another. Exemplary ornaments can include Jibbitz™, Snap-Itz™ or Shoe-Doodles™ charms, which are commercially available and have been used as accessories installable within, for example, CROCS™ shoes. Such ornaments can be installed within the aperture 130 much as they would be installed within an aperture of a bracelet or shoes. Other ornaments can include plastic jewels, charms, pins, buttons, and other decorative accessories.

The assemblage 300 indicates how embodiments of the invention can be used as or to create craft projects. The user can selectively choose desired units and connectors and then connect the elements as described above. In addition, the user can optionally determine to include one or more ornaments in the assemblage. In this manner, a user can create an assemblage of their own personal design.

According to another aspect of the invention, a kit including a plurality of decorative accessory units, connectors, and/or ornaments (collectively referred to here as elements) can be provided. Kits can include a number of elements sufficient for creating one or more decorative assemblages. A kit generally includes a variety of elements so that the user has a choice of elements to use. Some kits comprise elements having a common theme. Such themes can be, for example, color-based, subject-based, or demographically oriented. For example, a demographically themed kit can include decorative accessory elements relating to a particular age group, such as young children can be grouped. Ornaments can be included in kits, and/or may be made separately available. Moreover, users can acquire ornaments currently available and adapt them for use with embodiments of the invention.

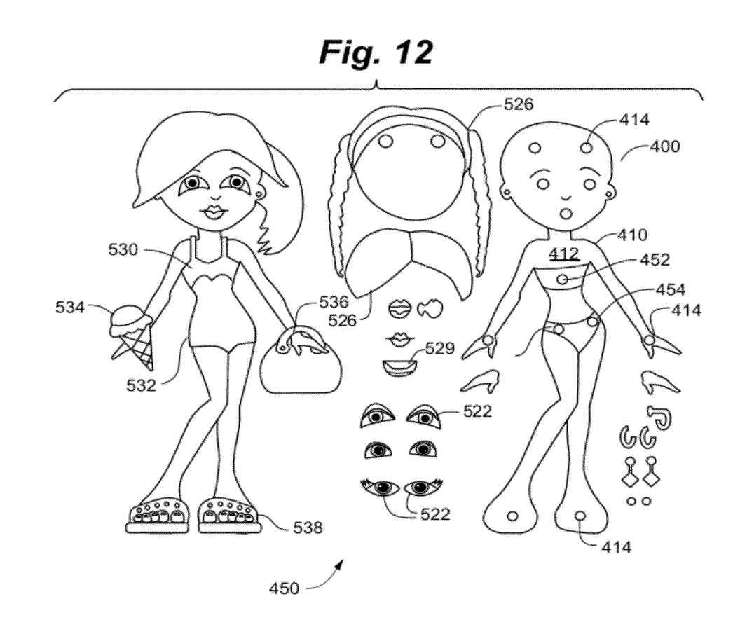

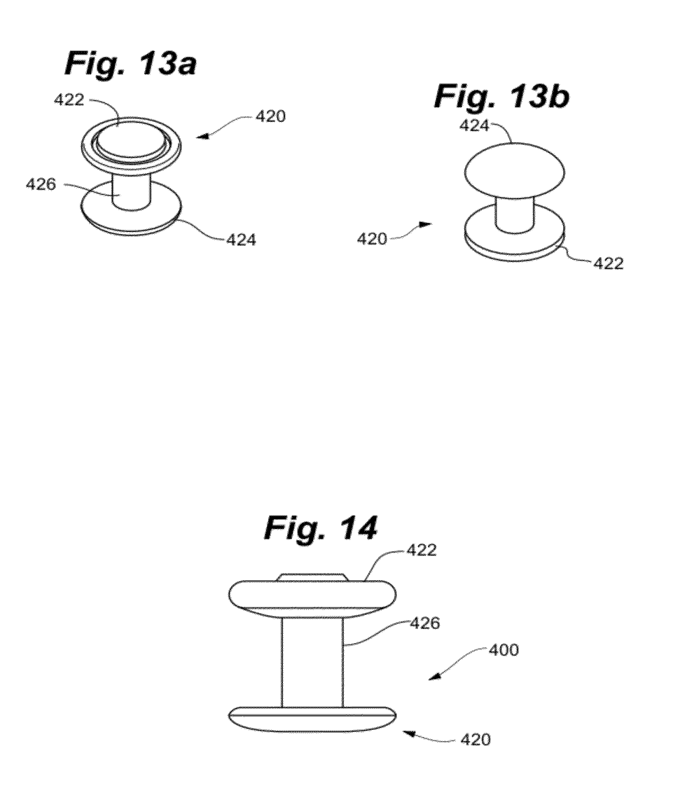

FIG. 12 illustrates front views of an assembled decorative item and an unadorned decoratable item including its various decorative connectors according to an embodiment of the invention. The decoratable item 400 is a generally a body 410 of planar material having a thickness and having edges defining a shape. The body 410 has a front surface 412 and a rear surface (not shown). In the embodiment shown in FIG. 12, the shape of the body 410 is in the form of a doll although other shapes are possible as will be described hereinafter. The body 410 has a plurality of apertures 414 located therein and passing thorough its thickness as seen on the right side of FIG. 12 which will be described in more detail with reference to FIGS. 13-16.

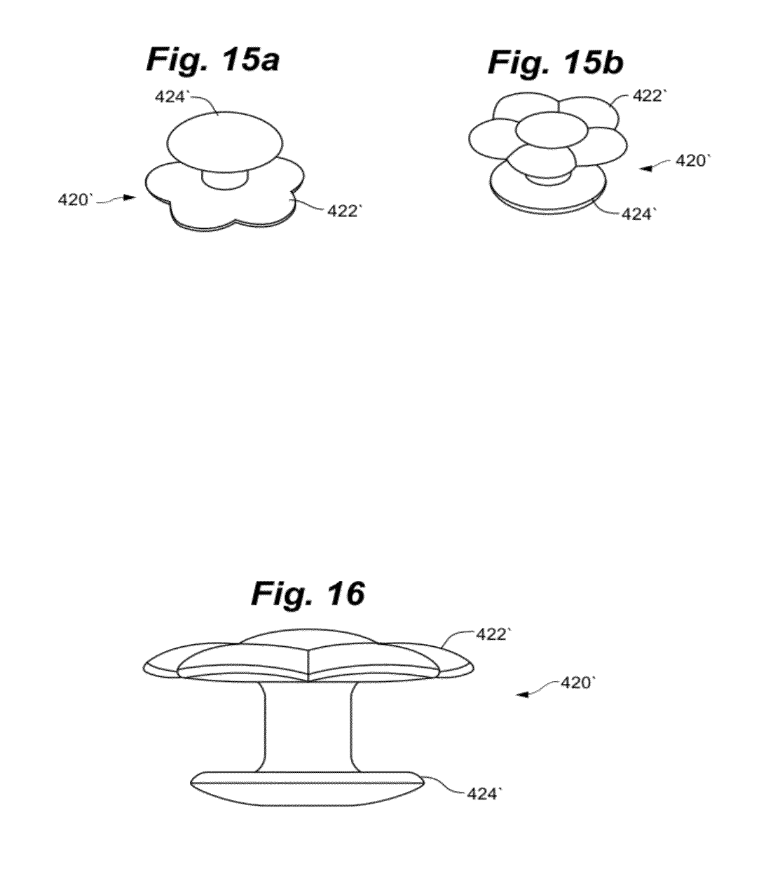

FIGS. 13a and b are perspective views of the rear and front, respectively, of a connector 420 according to a preferred embodiment of the invention. FIG. 14 is a perspective side view of the connector 420 shown in FIGS. 13 a and b. The connector 420 has a front 422 and a back 424 which are coupled together by a shank 426. Preferably, the connector 420 is formed as a unitary structure, however, it may also be formed by multiple pieces that are joined together by well known techniques, such as a bayonet connection. The back 424 of the connector is larger than the apertures 414 formed in the body 410. The body 410 is preferably made of a flexible, stretchable material and the back 424 of the connector 420 can be forced-fitted through an aperture 414 so that the back 424 of the connector 420 is located on the rear surface (not shown) of the body 410, the shank 426 resides substantially within the aperture 414 and the front 422 of the connector 420 is located on the front surface 412 of the body 410. In a preferred embodiment, the front 422 of the connector 420 is decorative as will be explained hereinafter. FIGS. 15a and b are perspective views of the front and rear respectively of a connector according to a preferred embodiment of the invention. FIG. 16 is a perspective side view of the connector shown in FIGS. 15a and b. The front surface 422′ of the connector 420′ shown in FIGS. 15 and 16 has a decorative shape, in this case, a flower. In the embodiment shown in FIG. 12, a plurality of connectors 450 are shown. The connectors 450 are like those shown in FIGS. 13-16. The fronts of the plurality of connectors 520 have a plurality of decorative fronts. Some of the connectors 520 are shown with an eye 522 on the front surface. With respect to the eye connectors, a pair of connectors form the pair of eyes and each pair has different features and expressions, as shown. Also shown in FIG. 12 are connectors 450 having mouths 524 as their decorative front surfaces exhibiting various expressions. Also, some of the connectors 450 have hair 526 as their decorative front surfaces. As shown in one of the hair connectors, apertures are formed therein and extend through the front of the connector so that another connector can be coupled to the body 410 on top of the hair connector. The additional connector may be an item such as a hat, for example. To the right of the unadorned body 410 are a plurality of additional connectors that have accessories as their decorative front surfaces, in this case, jewelry. On the left side of FIG. 12 is an assembled decorative item. Not all of the connectors that are used on the assembled body are shown separately in FIG. 12 but the same type of connector as shown in FIGS. 13-16 are used, they may have an infinitely various decorative fronts. Thus, the top 530 of the swimsuit is the decorative front of a connector that is inserted in aperture 452. The bottom 532 of the swimsuit has a front decorative appearance as trunks and the connector comprises two shanks (not shown) coupling the front surface (i.e., the swim trunks) with two backs (not shown) that fits through apertures 454. Also, decorative connectors 534 and 536 representing an ice cream cone and a handbag are coupled to the dolls hands and connectors representing shoes 538 are coupled to the doll's feet. Of course the decorative front of a connector can be any image and the invention is not limited to the particular embodiments shown.

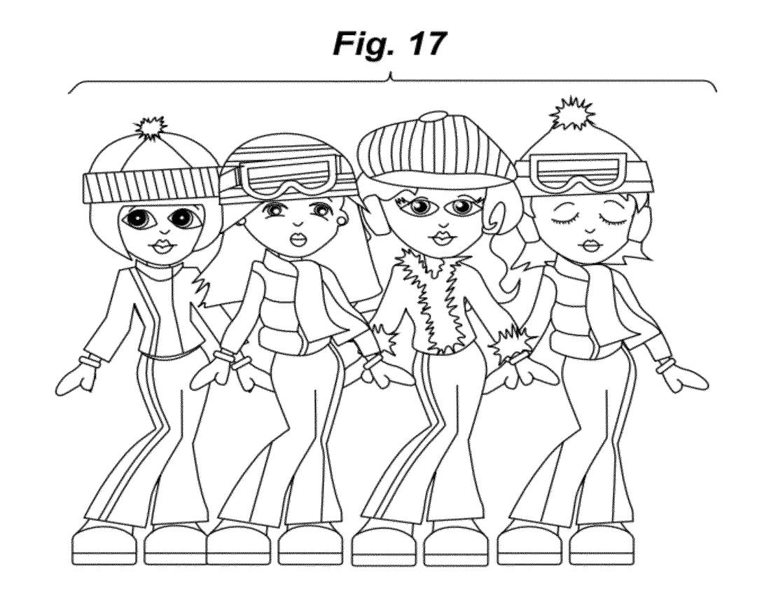

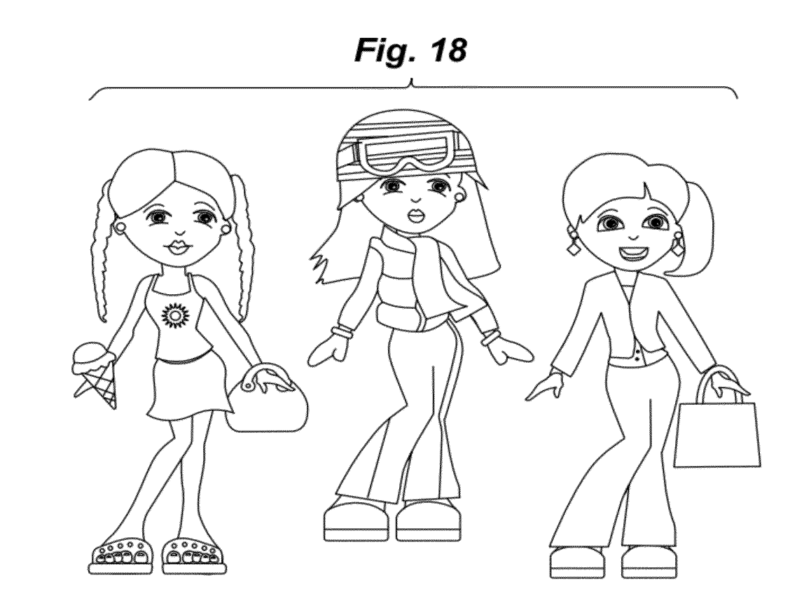

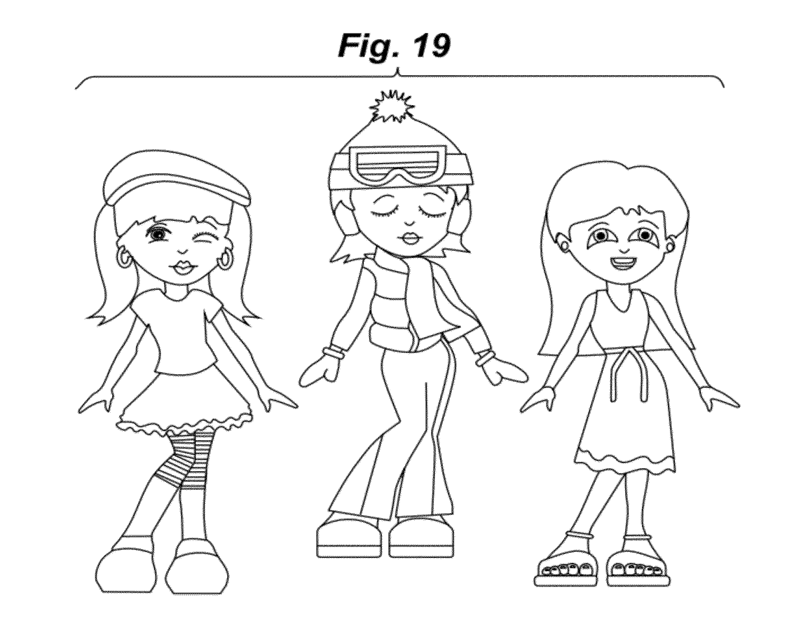

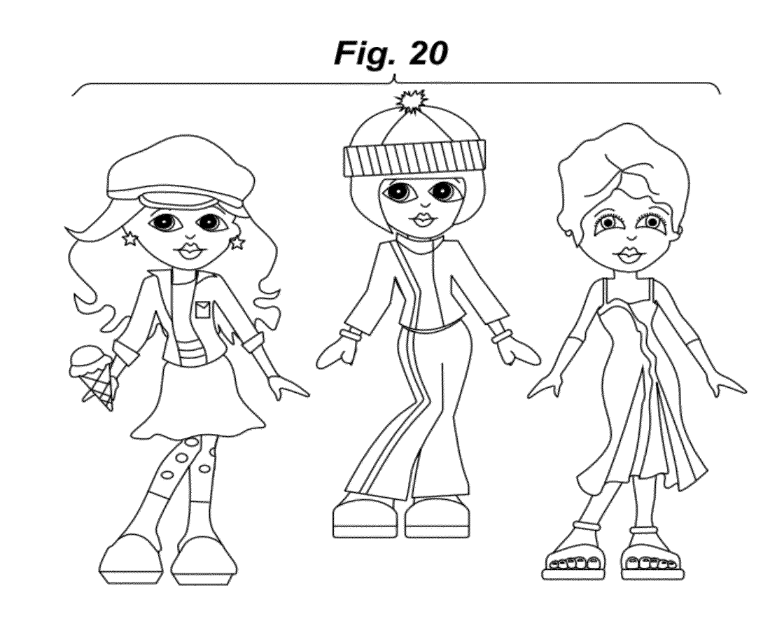

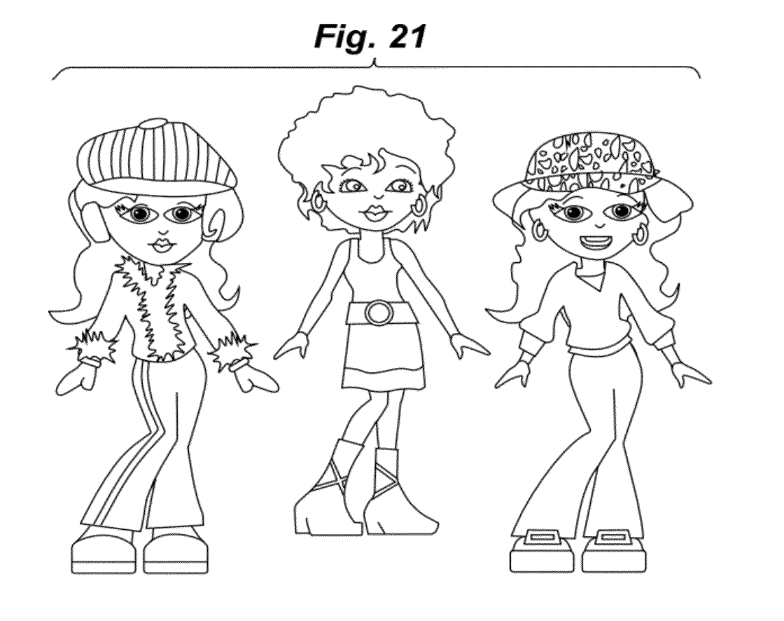

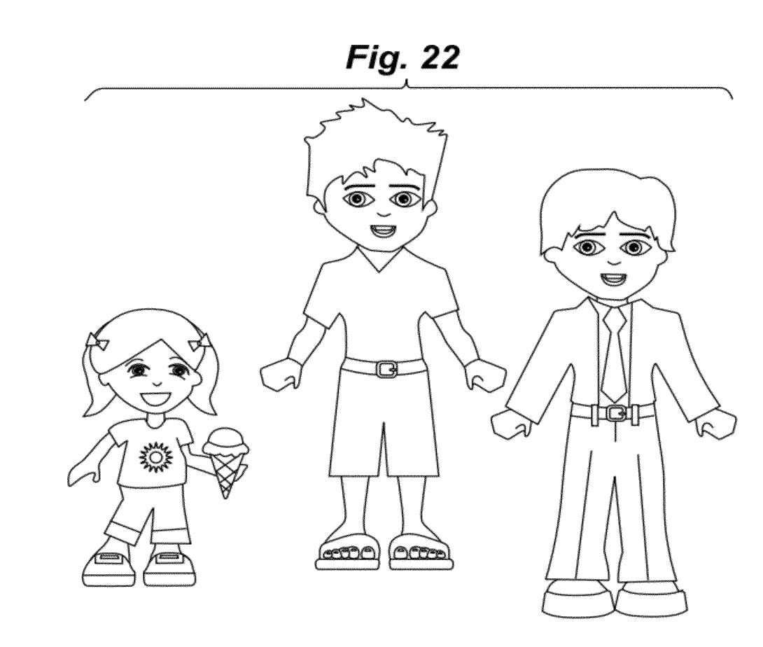

FIGS. 17-22 illustrate front views of assembled decorative items according to multiple embodiments of the invention. It can be seen that multiple bodies are shown with doll-like shapes. The color of the material of the body can vary to represent various ethnicities. Also, the shape of the body can be varied so that the doll is in different poses. Also, the doll may represent a girl or a boy. The decorative fronts of the connectors allow a user to decorate the doll according to the user's wish. For example, the doll may be decorated, such a for winter, summer, business, etc. as shown in FIGS. 17-22, which are merely an example.

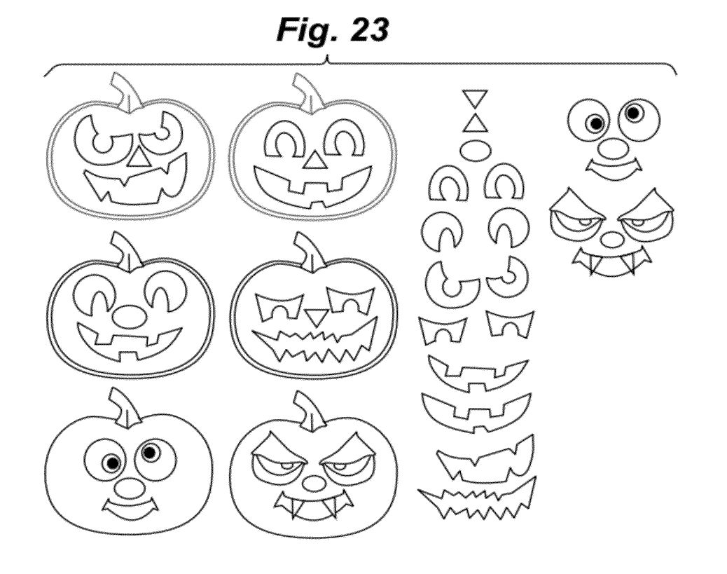

FIG. 23 illustrates front views of assembled decorative items as well as its unassembled parts according to another embodiment of the invention. In this case, the body 610 is that of a seasonal item, in this case, a pumpkin. The connectors 610 illustrate various features one might want to place of the front surface 612 of the body 610 in order to decorate it for the season. The connectors 620 are based on the same principle as discussed with reference to FIGS. 13-16, however, obviously their decorative fronts are different.

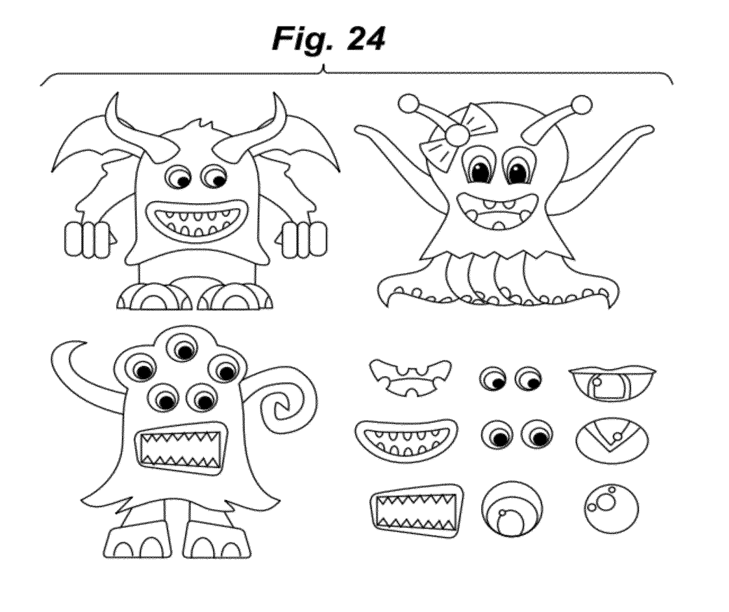

FIG. 24 illustrates front views of assembled decorative items as well as unassembled parts according to another embodiment of the invention. Like FIG. 23, the body 710 represents a figurine, in this case monsters and the connectors 720 have decorative fronts that one might want to use to decorate the front surface of the body 710. Apertures may be provided in various locations in the body were it would be desirable to attach a connector and the embodiment of the invention are not limited to those shown.

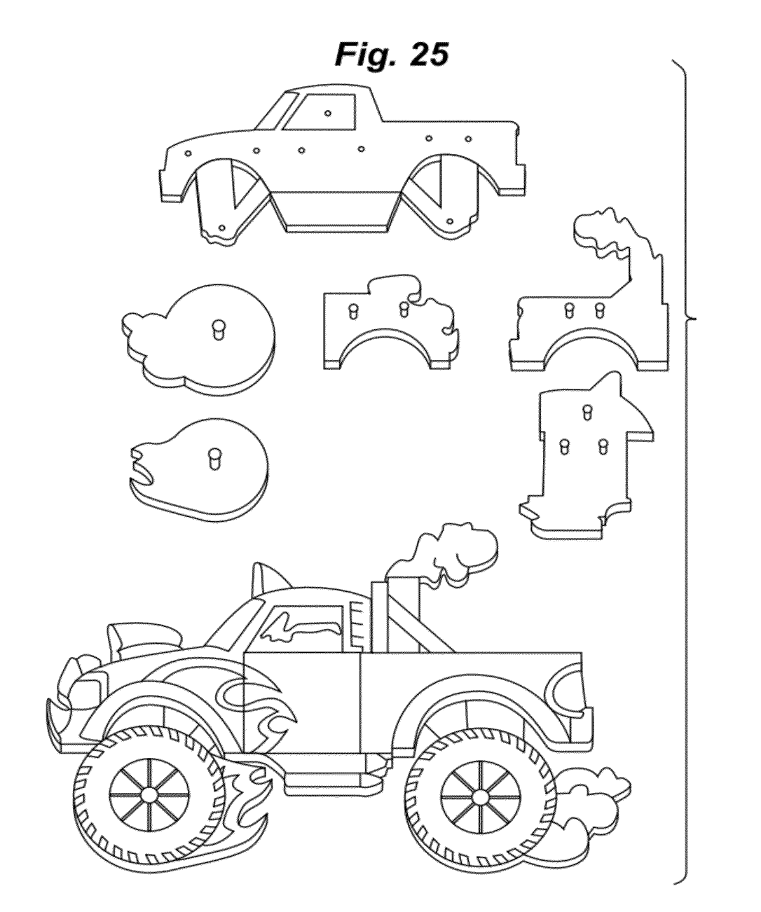

FIG. 25 illustrates front views of an assembled decorative item as well as unassembled parts according to another embodiment of the invention. The body 810 in FIG. 25 is that of a truck and the connectors 520 have decorative fronts that would be appropriate to decorate the body 810. In this illustration, the backs of the connectors are shown and it can be seen that the decorative fronts are typically larger than those shown in the other Figures. At the bottom of FIG. 25 is shown a decorative item where the connecters have been attached to the body 810.

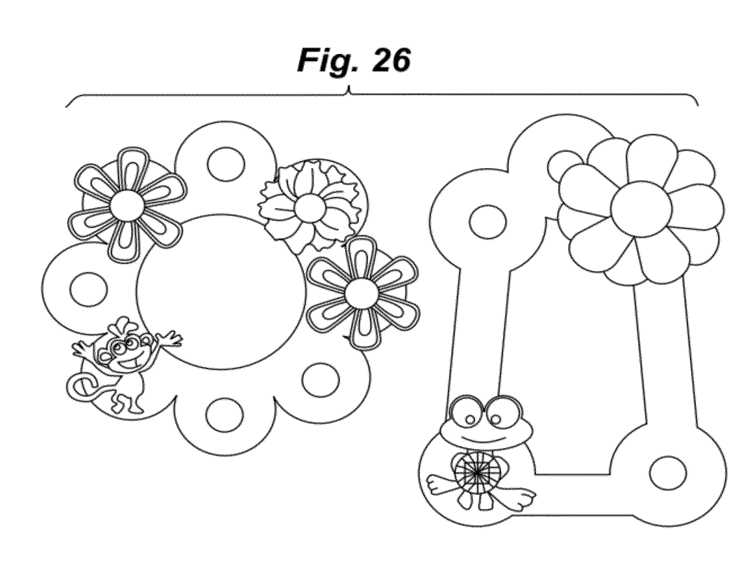

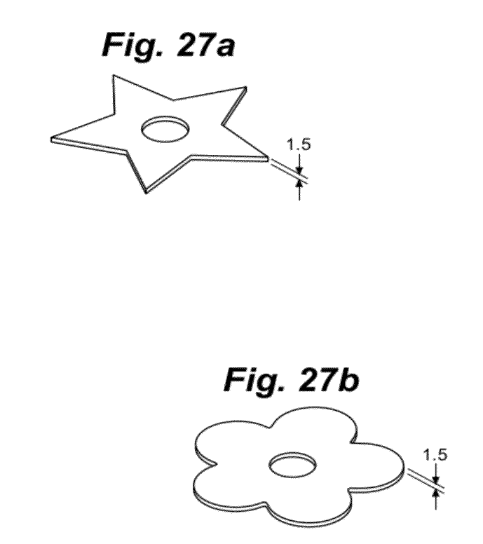

FIGS. 26a and b illustrate front views of two assembled decorative items according to another embodiment of the invention. In this case, the body 910 represents a picture frame having various apertures 914 to attach connectors 920. Some of the connectors 920 have a single decorative front whereas others have multiple fronts that are layered one over the other. For example, the flower shown in FIG. 26b is built using shapes such as that shown in FIGS. 27a and b that have an aperture therethough stacked over each other and then it is secured on place by a connector also having a decorative front. This, a user can make various designs and may change the designs as she wishes. The decorative connectors and shapes may also include holiday-themed decorations the a user can decorate the body for various occasions.

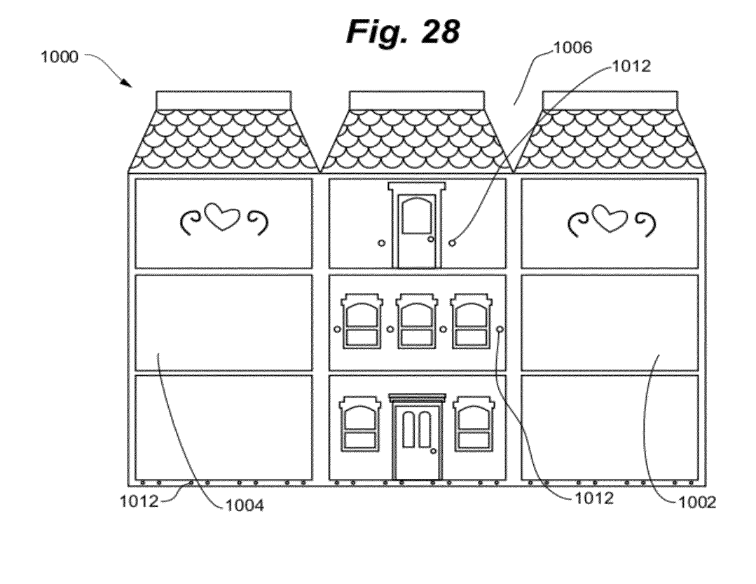

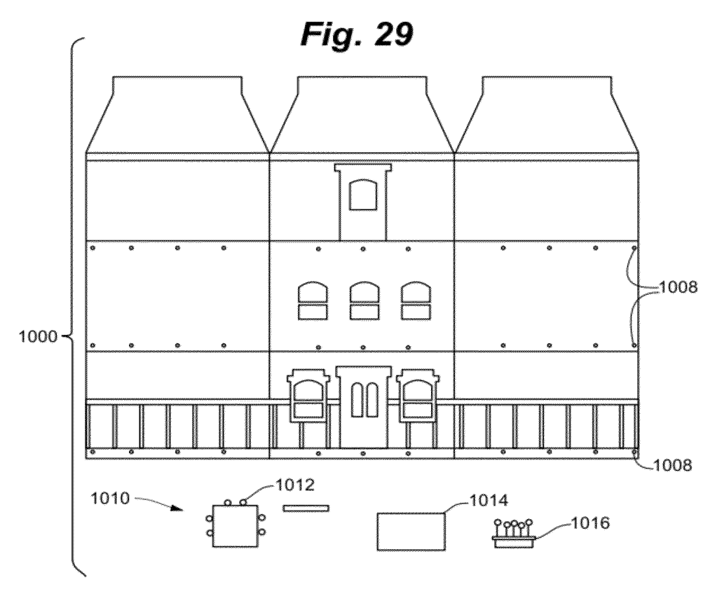

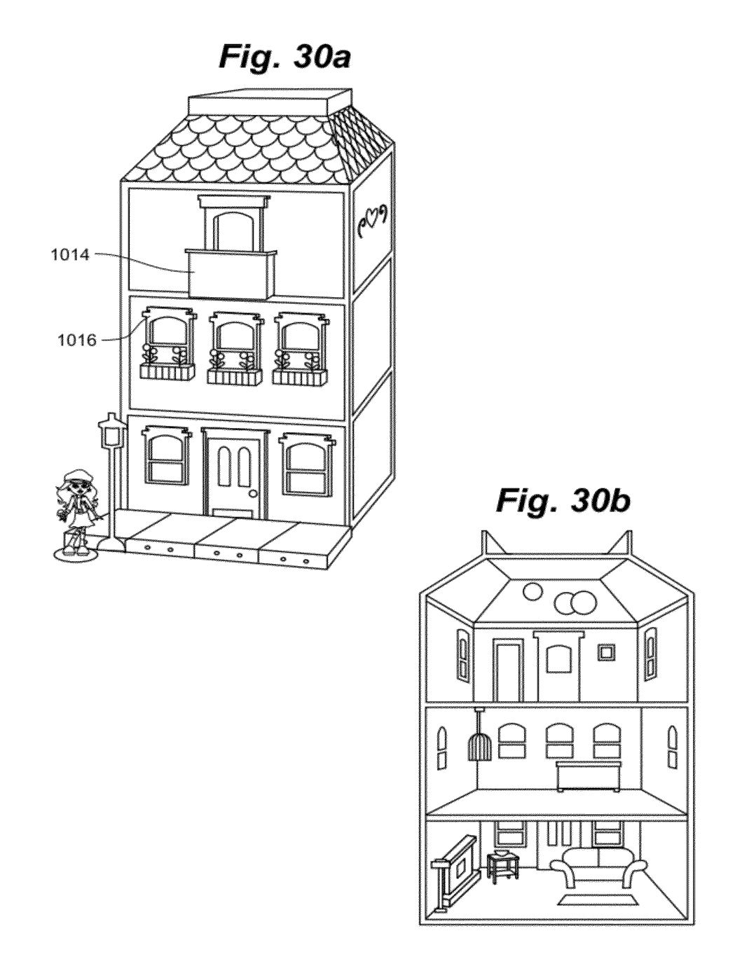

FIG. 28 is a front view of a building in its unconstructed state according to a preferred embodiment of the invention. FIG. 29 is a rear view thereof and FIGS. 30a and b are front and rear perspective views thereof in its constructed state. With reference to FIG. 28, the building in its unconstructed state comprises a body 1000 of a substantially planar piece of material preferably made of a stretchy material like the previous embodiments. General features are printed on the front of the body, such as windows and doors, for example. The rear of the body, shown in FIG. 29 is also printed with similar features. Also, the rear of the body 1000 defines rooms within the building once it is assembled. To construct the three-dimensional building shown in FIG. 30, the sides 1002, 1004 of the building are folded so that they are at 90 degrees with respect to the front 1006 of the building. Located on the rear of the body around floor dividing sections on the interior of the building are apertures that do not go though the thickness of the body. Floors (1010—not drawn to scale) may be introduced where appropriate and the floors have corresponding connectors 1012 located to match the apertures 1008 in the wall of the building. By putting the floors 1010 in place, the three-dimensional structure is created. Located on the exterior of the building are apertures 1012 that do not extend through the body to which decorations may be coupled to the building. For example, a balcony 1014 may be coupled to the exterior top floor of the building. The decorative piece, in this case the balcony, has two connectors (not shown—like those 1012 of floor 1010) locate at each end. The connectors are round-type posts that can be forced into the aperture in the body and held in place by friction fit. Unlike the connectors described with reference to FIGS. 1-26, they do not extend through the thickness of the body. Also, along the base of the building are apertures 1012 to which sidewalk links (which are like floors 1010 but smaller) may be coupled using the same principles already discussed. Coupled to the second level of the building are decorative connectors depicting flower beds 1016.

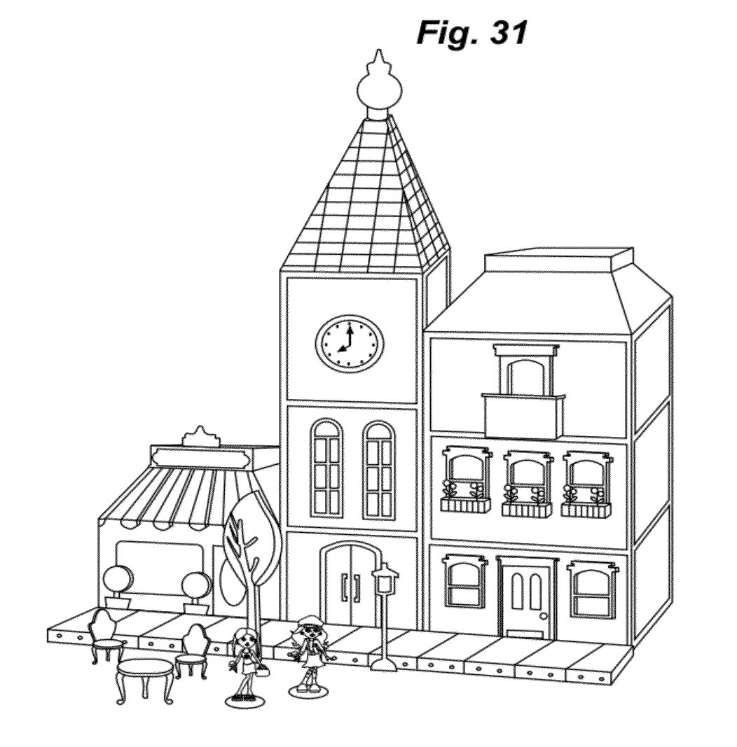

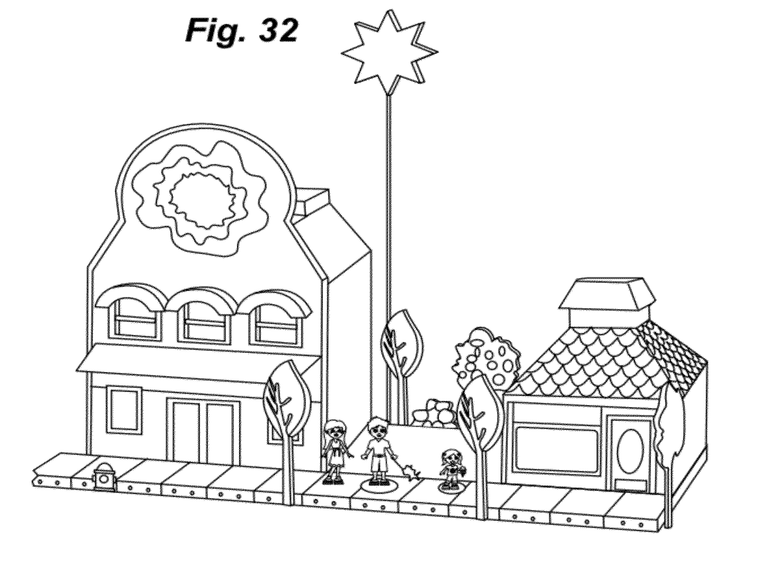

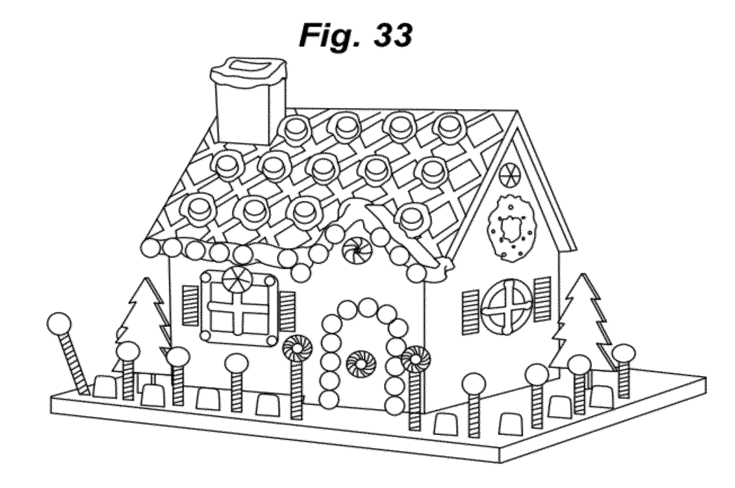

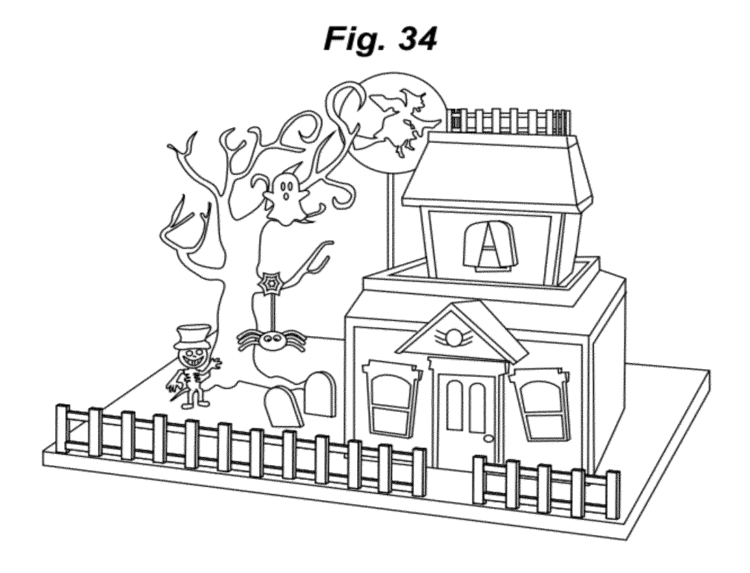

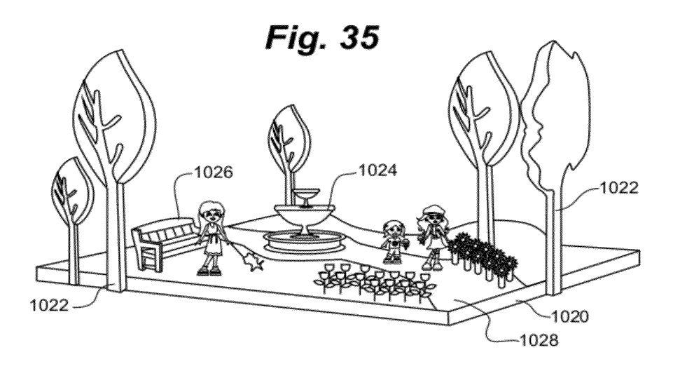

FIGS. 31 and 32 illustrate villages that can be created with building using the principles of the invention. It can be seen that decorative connectors depicting trees, lampposts and fire hydrants may be coupled to the scene created. FIGS. 33 and 34 also illustrate holiday-themed buildings. As shown in FIG. 33, instead of the building being created by folding substantially planar pieces, the building may be a three-dimensional structure to begin with. FIG. 35 illustrate a park that can also be built using bodies according to the embodiments of the invention. For example, a body representing the lawn 1020 may be provided with apertures along its exterior periphery. Connectors 1022 having trees as their decorative feature may be coupled to desired spots along the exterior periphery of the lawn 1020. On the surface of the lawn additional apertures may be provided and connectors having decorative features such as a fountain 1024, bench 1026, walkway 1028, etc. may be coupled to the surface of the lawn.

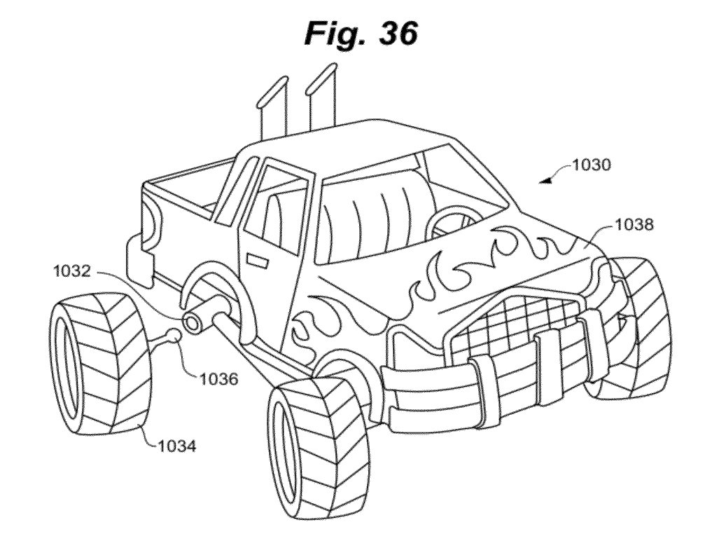

FIG. 36 is a perspective view of another embodiment of the invention. In this embodiment, the body 1030 is a three-dimensional structure provided with apertures to which decorative connectors 1034 may be attached. The connection system described with reference to the buildings may be used with such three-dimensional bodies in which the apertures in the body do not extend though the thickness of the body. The decorative features, such as the wheel 1034, have a connector end 1036 that can be force fitted into the aperture 1032 to hold it in place. Other features may likewise be provided, such as the decorative detailing 1038.

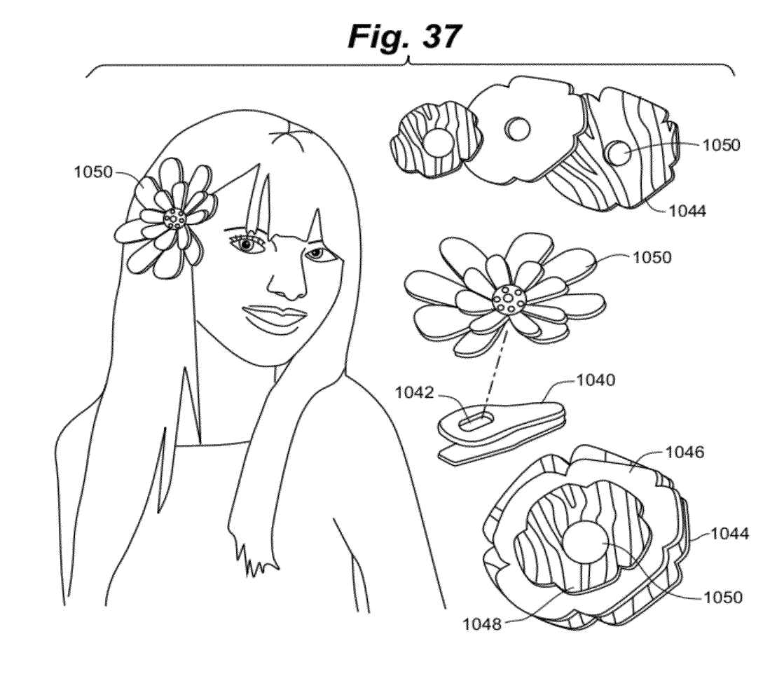

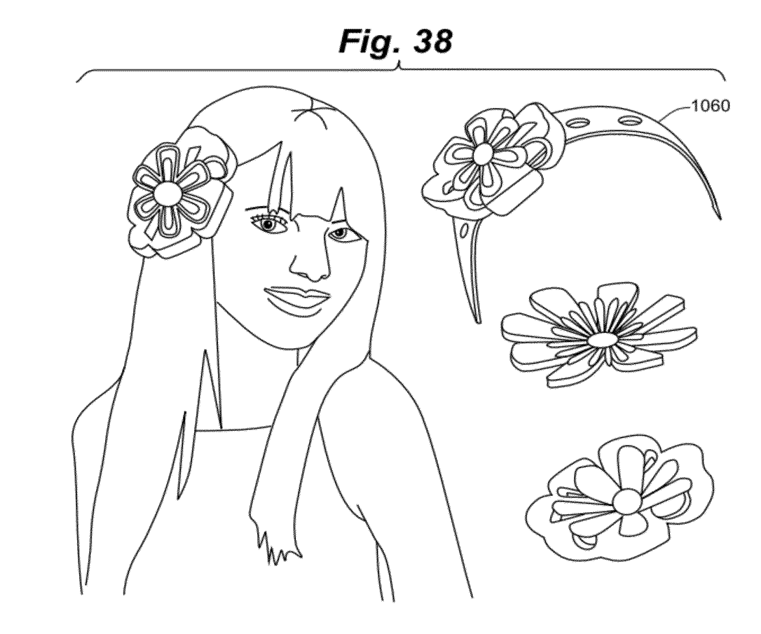

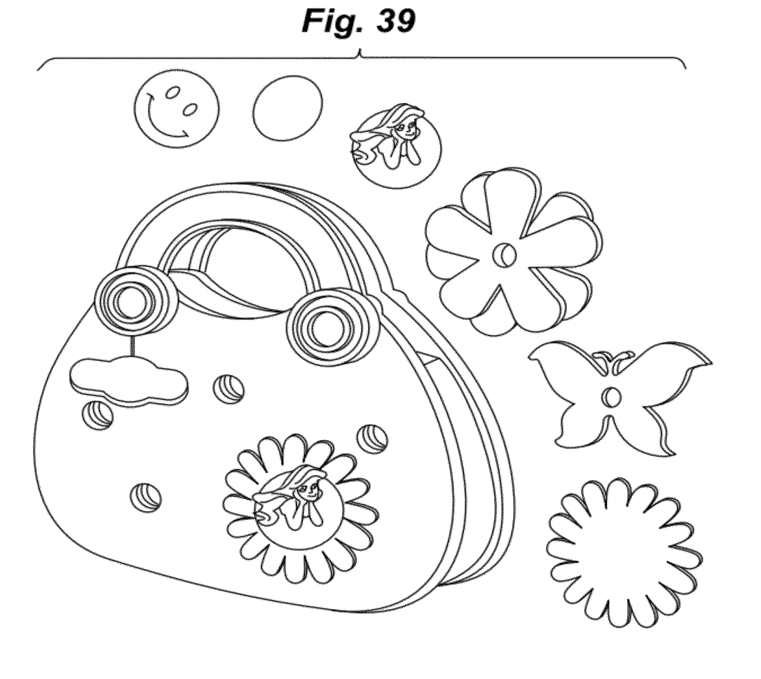

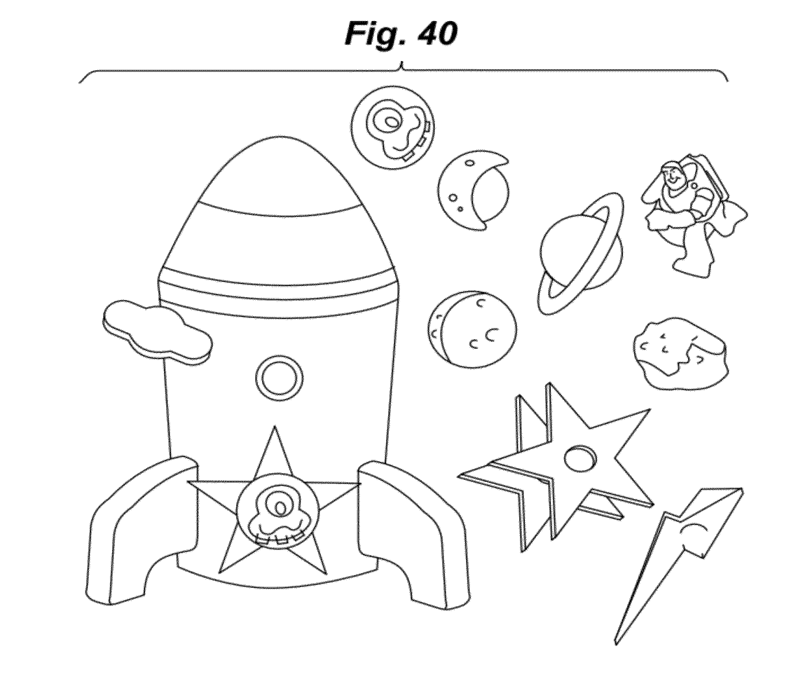

FIG. 37 illustrates another embodiment of the invention. Here the decorative unit to be created is a hair ornament. In particular, the body 1040 is a clip having therein an aperture 1042 extending there through. Several overlays 1044, 1046, 1048 may be provided with apertures 1050 that register with the aperture in the clip and a connector having a decorative front may secure the overlays to the clip as shown. FIG. 38 is similar but instead of the body being a clip, it is a headband 1060 having multiple apertures to which a decorative connector and/or overlays may be secured. FIG. 39 illustrates a purse utilizing the same concept. A user can thus have multiple bodies, such as the headband clip, purse body and a handful of connectors an overlays and create designs to suite their desires. FIG. 40 shows and three-dimensional body that is hollow in the interior and has a plurality of apertures through which decorative connectors with or with out overlays may be attached.

While dimensional information has been provided, the embodiments of the invention are not limited to those specifically stated and the various pieces may be larger or smaller than those described.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations, which fall within the spirit and broad scope of the invention.

What is claimed is:

1. A decorative accessory unit comprising:
a body comprising a generally planar material having edges defining a shape, the body having front and rear surfaces; and
at least two linking ends protruding from the edges of the body, each linking end comprising a stretchable material and having at least one connection aperture passing therethrough, each connection aperture configured to receive a connector.

2. The decorative accessory unit of claim 1, wherein the body includes an aperture configured to receive an ornament.

3. The decorative accessory unit of claim 1, wherein the connector is decorative.

4. The decorative accessory unit of claim 1, wherein at least one of the linking ends is a loopable end.

5. The decorative accessory unit of claim 1, wherein the linking ends comprise a strap operatively coupled to the rear surface of the body.

6. The decorative accessory unit of claim 5, wherein the strap comprises at least two strap segments, each segment separately coupled to the rear surface of the body.

7. The decorative accessory unit of claim 1, wherein the linking ends include a recessed connection aperture.

8. The decorative accessory unit of claim 1, wherein the decorative material comprises the same material as the stretchable material.

9. The decorative accessory unit of claim 1, wherein the stretchable material is EVA foam.

10. The decorative accessory unit of claim 2, wherein the aperture in the body is generally centrally located relative to the edges.

11. The decorative accessory unit of claim 2, wherein the ornament comprises a charm having a decorative face and a post protruding from a bottom surface of the decorative face, the post having a wide base end.

12. A decorative item comprising:
a body comprising a generally planar material having a thickness and having edges defining a shape, the body having a front surface and a rear surface;
a plurality of apertures located in the body and passing through the thickness of the body; and
a plurality of connectors, each connector having a front, a back and a shank coupling the front to the back of the connector, wherein the back of the connector is larger than the aperture and fits through the aperture to accommodate the back of the connector so that the back of the connector passes through the aperture and the shank resides substantially in the aperture so that the front of the connector is located on the front surface of the body and the back of the connector is located on the rear surface of the body and wherein the front of the connector has a decorative appearance.

13. The item according to claim 12 wherein the front of the connector is three dimensional.

14. The item according to claim 12 wherein the body is in the shape of a doll.

15. The item according to claim 14 wherein the plurality of apertures includes a first group of apertures that are located where the doll's facial features should be.

16. The item according to claim 15 wherein a first group of the plurality of connectors have a front that has a decorative appearance that comprises one or more items selected form the group consisting of eyes, mouth and hair.

17. The item according to claim 15 wherein a second group of the plurality of connectors have a front that has a decorative appearance that comprises one or more items selected form the group consisting of shoes, handbags, jewelry, clothing and accessories.

18. The item according to claim 17 wherein the plurality of apertures includes a second group of apertures that are located in appropriate locations of the doll to place the second group of the plurality of connectors.

19. An item according to claim 12 wherein the body is in the shape of a building and the plurality of apertures include apertures located where building features should be.

20. The item according to claim 12 wherein the body is in the shape of a vehicle and the plurality of apertures include apertures located where vehicle features should be.

21. A kit for decorative items comprising:
a plurality of bodies, each body comprising a generally planar material having a thickness and having edges defining a shape, the body having a front surface and a rear surface;
a plurality of apertures located in each of the plurality of bodies and passing through the thickness of each body; and
a plurality of connectors, each connector having a front, a back and a shank coupling the front to the back of the connector, wherein the back of the connector is larger than the aperture and fits through the aperture to accommodate the back of the connector so that the back of the connector passes through the aperture and the shank resides substantially in the aperture so that the front of the connector is located on the front surface of the body and the back of the connector is located on the rear surface of the body and wherein the front of the connector has a decorative appearance.
